(19) United States
(12) Patent Application Publication
(10) Pub. No.: US 2024/0104584 A1
(43) Pub. Date: Mar. 28, 2024

(54) GRAPHICAL, INCREMENTAL ATTRIBUTION MODEL BASED ON CONDITIONAL INTENSITY

(71) Applicant: Adobe Inc., San Jose, CA (US)

(72) Inventors: James William Snyder, JR., Sunnyvale, CA (US); Sai Kumar Arava, Santa Clara, CA (US); Amirhossein Meisami, Menlo Park, CA (US); Jun Tao, State College, PA (US)

(21) Appl. No.: 17/948,914

(22) Filed: Sep. 20, 2022

(51) Int. Cl. G06Q 30/02

(52) U.S. Cl. CPC G06Q 30/0201

(57) ABSTRACT

Methods and systems are provided for facilitating generation and utilization of causal-based models. In embodiments described herein, a set of events comprising touchpoints resulting in a conversion are obtained. A direct attribution indicating credit for an event contribution to the conversion is determined. An adjusted attribution for the event based on the direct attribution for the event augmented with an indirect attribution for the event is determined. The indirect attribution can be identified based on the event causing a subsequent event of the set of events to result in the conversion. Thereafter, the adjusted attribution for the event is provided to indicate an extent of credit assigned to the event for causing the corresponding conversion.

### BACKGROUND

Various marketing analysis tools utilize attribution models to analyze data. An attribution model generally refers to a model that determines credit for an outcome. Attribution seeks to assign a proportion of credit attributed to a particular outcome, such as a conversion (e.g., a web order). Upon generating attributions via an attribution model, such attributions can be input to a marketing analysis tool (e.g., ROI analysis), budget optimization analysis, and the like.

### SUMMARY

Embodiments disclosed herein are directed to facilitating generation and utilization of causal-based attribution models. In particular, the technology described herein provides an efficient causal-based attribution model used to determine attributions for various events, or touchpoints, of event paths leading to conversions. At a high level, using a causal-based attribution model enables back propagation of attribution credit to earlier events or touchpoints that cause later events or touchpoints, thereby capturing causal relationships between different marketing touchpoints. Advantageously, using a causal-based attribution model enables a more accurate estimation of contribution from various events. In particular, redistributing attribution credit from later touchpoints to earlier touchpoints, in cases in which the earlier touchpoints were found to cause later touchpoints, provides the earlier touchpoints that drive other touchpoints with higher credit.

In embodiments, a conditional intensity model is used to determine attribution for events. In implementation, in determining conditional intensities, a baseline parameter and a causal parameter (e.g., Granger causality parameter) are used. Such parameters are learned during training of the conditional intensity model. In this regard, the conditional intensity model is trained to fit the baseline parameter and the causal parameter to result in a function that measures the propensity of an event occurring in a certain time span. To efficiently train the conditional intensity model, hyperparameters can be determined such that it is set in advance of learning the baseline and causal parameters. Stated differently, to facilitate learning of baseline parameters and/or causal parameters, hyperparameters, such as a sigma (or a) parameter, is established in advance of training the conditional intensity model. In accordance with embodiments described herein, the predetermined hyperparameters are determined in an efficient and scalable manner prior to performing machine learning to learn model parameters.

### BRIEF DESCRIPTION OF THE DRAWINGS

FIG. 1 depicts a diagram of an environment in which one or more embodiments of the present disclosure can be practiced, in accordance with various embodiments of the present disclosure;

FIG. 2 depicts an example configuration of an operating environment in which some implementations of the present disclosure can be employed, in accordance with various embodiments of the present disclosure;

FIG. 3 illustrates an example event path, in accordance with embodiments of the present disclosure;

FIG. 4 provides an example causal graph, in accordance with embodiments of the present disclosure;

FIG. 5 provides an example graphical representation of line plot for conditional intensity associated with events, in accordance with embodiments of the present disclosure;

FIG. 6 provides an example graphical representation of line plot for conditional intensity associated with events with adjusted attributions, in accordance with embodiments of the present disclosure;

FIG. 7 is a process flow showing a method for determination of adjusted attribution for an event, in accordance with embodiments of the present disclosure;

FIG. 8 is a process flow showing a method for facilitating generation of a causal-based model, in accordance with embodiments of the present disclosure; and

FIG. 9 is a block diagram of an example computing device in which embodiments of the present disclosure may be employed.

### DETAILED DESCRIPTION

Various marketing analysis tools utilize attribution models to analyze data. Generally, an attribution model refers to a model that determines credit for an outcome. Attribution generally seeks to assign a proportion of credit attributed to a particular outcome, such as a conversion (e.g., a web order). Upon generating attributions via an attribution model, such attributions can be input to a marketing analysis tool (e.g., ROI analysis), budget optimization analysis, and the like.

A variety of rules-based approaches have been used to determine attribution. For example, a last touch attribution model, a first touch attribution model, a linear attribution model, a u-shape attribution model, and an exponential decay attribution model have been used to assign attributions to events. More recently, algorithmic models have been developed and applied to multichannel attribution problems to learn relationships between touchpoints and conversions. One example algorithmic approach is a time-survival modeling with a logistic link. Such an approach, however, fails to capture causal relationship between different marketing touchpoints and, as a result, may not sufficiently distribute credit to earlier touchpoints effectuating subsequent touchpoints. For example, a display ad often prompts a user to click paid search ads later which may result in a conversion. Without modeling the relationship between display and paid search ad, the credit for the display ad may be underestimated and the paid search ad overestimated. The logistic link function, for example used in logistic regression and neural networks, may also be saturated, which can result in later touchpoints receiving very little credit.

As such, embodiments disclosed herein are directed to facilitating generation and utilization of causal-based attribution models. In particular, the technology described herein provides an efficient causal-based attribution model used to determine attributions for various events, or touchpoints, of event paths leading to conversions. At a high level, using a causal-based attribution model enables back propagation of attribution credit to earlier events or touchpoints that cause later events or touchpoints, thereby capturing causal relationships between different marketing touchpoints. Advantageously, the causal-based attribution approach models long-term interactions between events as well as the time-decaying relationship between touchpoints and conversions.

In operation, in determining an attribution for an event using a causal-based model, a direct attribution is determined for the event. Generally, the direct attribution refers to attribution directly caused by the event to result in a conversion. The direct attribution is augmented or aggregated with an indirect attribution to determine an adjusted attribution, or final attribution, for the event. The indirect attribution is generally identified based on the event causing a subsequent event to result in the conversion. In this way, at least a portion of an attribution determined for the subsequent event is distributed back to the event causing the subsequent event, thereby augmenting the attribution for the event.

By way of example only, assume two different events, or touchpoints, exist on an event path resulting in a conversion. In particular, assume a second touchpoint representing a search event is excited by a prior first touchpoint. For example, a first touchpoint of a user exposed to an email with a keyword of a product may result in the second touchpoint of the user subsequently initiating a search of the keyword. As such, the second touchpoint representing a search event is excited by the previous first touchpoint of the email exposure. In determining the marginal impact, or attribution, of the prior first touchpoint of the email event, the first touchpoint email event impacts the subsequent second touchpoint search event. As such, when analyzing attribution associated with the second touchpoint, at least a portion of the attribution for the second touchpoint is redistributed to the first touchpoint in account for the contribution or causation of the second touchpoint resulting from the first touchpoint. A direct attribution determined for the first touchpoint is augmented with this redistributed attribution, or indirect attribution to generate a more accurate attribution for the first touchpoint.

In embodiments, a conditional intensity model is used to determine attribution for events. A conditional intensity model refers to a spatial point process describing how the probability that an event in the process occurs at a particular point depends on the prior point events in the process. In implementation, in determining conditional intensities, a baseline parameter and a causal parameter (e.g., Granger causality parameter) are used. A baseline parameter generally indicates an extent of propensity for an event to occur without any stimulus. A causal parameter generally indicates an extent of excitation on an occurrence of another event. Such parameters are learned during training of the conditional intensity model. In this regard, the conditional intensity model is trained to fit the baseline parameter and the causal parameter to result in a function that measures the propensity of an event occurring in a certain time span. To efficiently train the conditional intensity model, hyperparameters, such as sigma, can be determined such that they are set in advance of learning the baseline and causal parameters. Stated differently, to facilitate learning of baseline parameters and/or causal parameters, hyperparameters are established in advance of training the conditional intensity model. In particular, the machine learning algorithms can include preset hyperparameters, including the sigma parameters. Such a sigma hyperparameter determines or specifies the rate of decay function.

In accordance with embodiments described herein, the hyperparameters, such as sigma, can be determined in an efficient and scalable manner prior to performing machine learning to learn model parameters. In particular, the sigma hyperparameters can be determined by fitting an exponential to the distribution of time differences between two events of paired type (e.g., the conversion and search click) where both events used in each difference are drawn from the same event path. In this way, every event pair can have a unique sigma. By way of example only, assume a conversion and a display event occur at two different times. In such a case, a distribution can be generated in association with the event pair and, thereafter, an exponential fit to the distribution. In embodiments, a regression machine learning approach is used to perform the exponential fit to the distribution. Other distributions with additional or different hyperparameters may be used in place of the exponential distribution, and the fitting procedure would remain essentially the same, except the alternative distribution and hyperparameters would be used in the fit.

Advantageously, using a causal-based attribution model enables a more accurate estimation of contribution from various events. In particular, redistributing attribution credit from later touchpoints to earlier touchpoints, in cases in which the earlier touchpoints were found to cause later touchpoints, provides the earlier touchpoints that drive other touchpoints with higher credit. As such, the back propagation of credit provides a more accurate distribution of credit, as opposed to conventional implementations that distribute credit roughly equally with more credit going to touchpoints that are somewhat more strongly correlated with the conversion. Further, such an implementation described herein is performed in a computationally efficient manner. In this regard, in training a conditional intensity model which is used for determining attributions, hyperameters, such as sigma, associated with the rate of decay and/or other factors that define the relationship between events are preset in a computationally efficient manner. As described herein, determining sigma via a simple exponential fit can be performed very efficiently (e.g., in seconds), which is much more computationally efficient as compared to performing a grid search to identify the sigma hyperparameters. Identifying or selecting the hyperparameters in advance of training enables a scalable process.

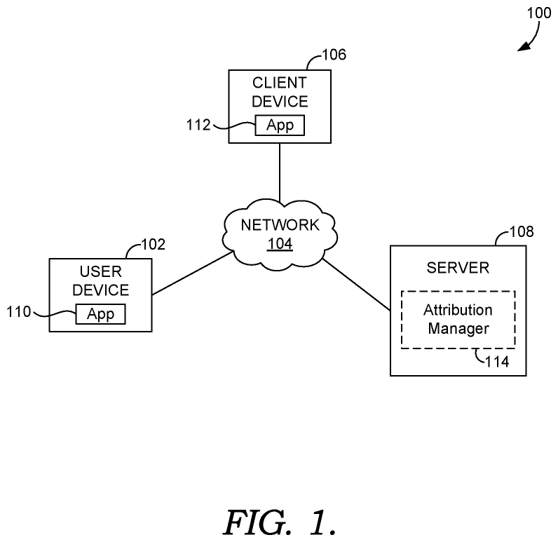

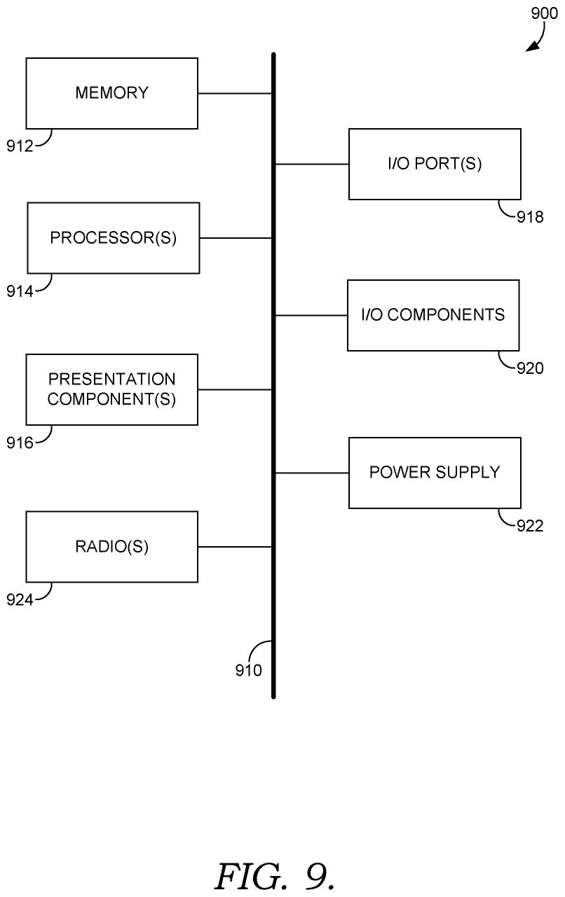

Turning to FIG. 1, FIG. 1 depicts an example configuration of an operating environment in which some implementations of the present disclosure can be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by a processor executing instructions stored in memory as further described with reference to FIG. 9.

It should be understood that operating environment 100 shown in FIG. 1 is an example of one suitable operating environment. Among other components not shown, operating environment 100 includes user device(s) 102, network 104, client device(s) 106, and server(s) 108. Each of the components shown in FIG. 1 may be implemented via any type of computing device, such as one or more of computing device 900 described in connection to FIG. 9, for example. These components may communicate with each other via network 104, which may be wired, wireless, or both. Network 104 can include multiple networks, or a network of networks, but is shown in simple form so as not to obscure aspects of the present disclosure. By way of example, network 104 can include one or more wide area networks (WANs), one or more local area networks (LANs), one or more public networks such as the Internet, and/or one or more private networks. Where network 104 includes a wireless telecommunications network, components such as a base station, a communications tower, or even access points (as well as other components) may provide wireless connectivity. Networking environments are commonplace in offices, enterprise-wide computer networks, intranets, and the Internet. Accordingly, network 104 is not described in significant detail.

It should be understood that any number of user devices, client devices, servers, and other components may be employed within operating environment 100 within the scope of the present disclosure. Each may comprise a single device or multiple devices cooperating in a distributed environment.

User device 102 and client device 106 can be any type of computing device capable of being operated by a user. For example, in some implementations, such devices are the type of computing device described in relation to FIG. 9. By way of example and not limitation, user devices and client devices may be embodied as a personal computer (PC), a laptop computer, a mobile device, a smartphone, a tablet computer, a smart watch, a wearable computer, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

The user device and client device can include one or more processors, and one or more computer-readable media. The computer-readable media may include computer-readable instructions executable by the one or more processors. The instructions may be embodied by one or more applications. The application(s) may generally be any application capable of facilitating analysis of attribution models. In some implementations, the application(s) comprises a web application, which can run in a web browser, and could be hosted at least partially server-side (e.g., via attribution manager 114). In addition, or instead, the application(s) can comprise a dedicated application. In some cases, the application is integrated into the operating system (e.g., as a service). An application may be accessed via a mobile application, a web application, or the like.

User device and client device can be computing devices on a client-side of operating environment 100, while the server 108 can be on a server-side of operating environment 100. The attribution manager 114 may comprise server-side software designed to work in conjunction with client-side software on user device and/or client device so as to implement any combination of the features and functionalities discussed in the present disclosure. This division of operating environment 100 is provided to illustrate one example of a suitable environment, and it is noted there is no requirement for each implementation that any combination of user device, client device, and/or attribution manager to remain as separate entities.

The client device 106 may be any device with which a client interacts. As used herein, a client generally refers to an individual, such as a consumer, that is being monitored in association with events. In this way, a client can be an individual that performs, initiates, interacts, or engages with a website, application, etc. Clients do not need to be pre-identified, that is, an individual may become client by virtue of engaging in an initial event of a journey. A client may interact with the client device 106 via a graphical user interface associated with an application or web site (e.g., a web site or set of web sites for which marketing analysis is being performed). Such interactions with the client device 106 may be monitored and tracked. In some cases, the client device 106 (e.g., via an application 112) may recognize or detect events. In other cases, another component (e.g., a server interacting with the client device) may monitor or detect such events occurring in association with a journey or event path. A journey or event path generally refers to a set of events (e.g., sequence of events), for example, related to marketing. An event path or journey may include any number of events, segments or portions.

In accordance with embodiments herein, the user device 102 can facilitate analysis of attributions. In operation, a user may select to initiate analysis of one or more attribution models via an application 110 (e.g., a marketing analytics application). For example, a user may indicate a desire to identify attributions using a causal-based attribution model in attributing events to achieving a metric or goal. In some cases, a user may specify the causal-based attribution model for which analysis is to be performed. In other cases, a causal-based attribution model may be automatically selected (e.g., all attribution models are selected by default). In embodiments, a user may indicate or specify a data set to be analyzed in association with the attribution model. For example, a user may specify a date range, a demographic, or the like, for which event paths are to be analyzed. Additionally or alternatively, default settings may be used to perform attribution analysis (e.g., all event paths within the last month, etc.). Such a selection of attribution models and/or data set attributes may be obtained by the user device 102 via a graphical user interface. Based on the analysis of the attribution model, the user device 102 can provide various information related to the attribution model analysis (e.g., via application 110). For example, attributes and/or insights associated therewith can be presented to a user via the user device 102. Attributions and/or corresponding insights can be presented in any manner, and the analysis details and/or manner in which they are presented are not intended to be limiting to the examples provided herein.

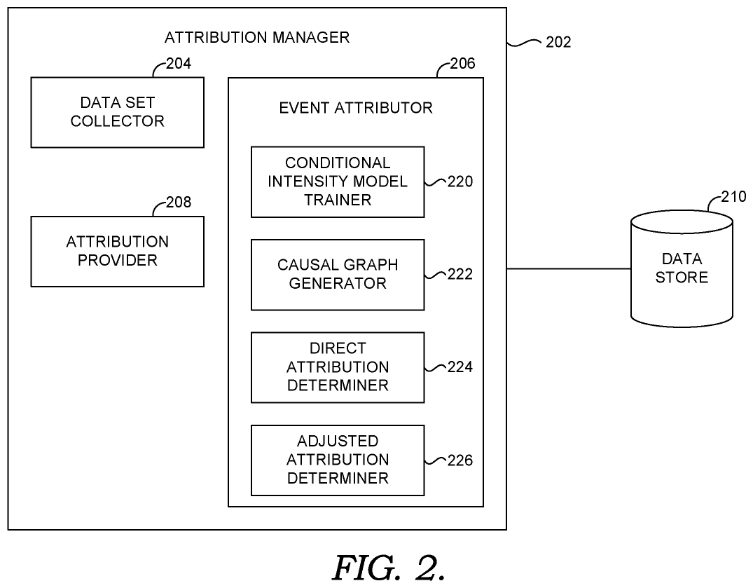

As described herein, server 108 can facilitate analysis of attribution models via attribution manager 114. Server 108 includes one or more processors, and one or more computer-readable media. The computer-readable media includes computer-readable instructions executable by the one or more processors. The instructions may optionally implement one or more components of attribution manager 114, described in additional detail below with attribution manager 202 of FIG. 2. At a high level, attribution manager 114 analyzes events using a causal-based attribution model to identify attributions in association with such events. For example, a causal-based attribution model may be used to efficiently determine attributions of events to provide a more effective attribution of the events. Generally, in addition to crediting attribution to an event associated with a direct effect on a conversion, the causal-based attribution approach also applies an indirect credit to the event when the event excites or impacts a subsequent event in the event sequence that results in a conversion.

For cloud-based implementations, the instructions on server 108 may implement one or more components of attribution manager 114, and an application residing on user device 102 may be utilized by a user to interface with the functionality implemented on server(s) 108. In other cases, server 108 may not be required. For example, the components of attribution manager 114 may be implemented completely on a user device, such as user device 102. In this case, attribution manager 114 may be embodied at least partially by the instructions corresponding to an application operating on the user device 102.

Thus, it should be appreciated that attribution manager 114 may be provided via multiple devices arranged in a distributed environment that collectively provide the functionality described herein. Additionally, other components not shown may also be included within the distributed environment. In addition, or instead, attribution manager 114 can be integrated, at least partially, into a user device, such as user device 102, and/or client device, such as client device 106. Furthermore, attribution manager 114 may at least partially be embodied as a cloud computing service.

Referring to FIG. 2, aspects of an attribution manager 202 are shown, in accordance with various embodiments of the present disclosure. At a high level, an attribution manager 202 manages analysis of attributions for various events in event paths. In this regard, the attribution manager 202 can analyze event paths via a causal-based attribution approach to identify attributions for events.

Generally, there are multiple events or touchpoints, such as ad presentations and user selections/navigations, occurring before a conversion is actually performed. Because of the multiple events leading up to a conversion, it is oftentimes desirable to attribute revenue that is appropriate to each of these events or touchpoints, as appropriate, to designate an event or set of events as contributing to the conversion. As such, determining attribution provides an indication of an event(s) that influences individuals to engage in a particular behavior, resulting in a revenue gain or conversion. Accordingly, generally, attribution is used to quantify the influence an event(s) has on a consumer's decision to make a purchase decision, or convert. By attributing revenue to an event(s), historical revenue data and patterns can be identified and used to allocate advertising budget.

By way of example only, assume that several events precede a conversion including a first event of an advertisement being displayed on first page, a second event of a user clicking on one or more of advertisements, and a third event of a related posting on a social networking website. Based on a causal-based attribution model, one or more of the events can be selected for attributing the revenue associated with the conversion. To this end, the conversion revenue can be attributed to the advertisement display, the advertisement selection, and/or the social network posting. Upon attributing revenue to one or more events, such data can be used to determine an allocation on an allotted budget. Although this example refers to revenue associated with a conversion, as can be appreciated, conversions do not need to relate or correspond to revenue. For instance, a conversion may include a website visit, which does not necessarily result in revenue.

As described herein, an attribution model refers to a model that determines or identifies attribution, or a portion of credit, to events of an event path. Such an event path can correspond with an outcome or goal, such as a successful marketing outcome (e.g., a conversion). In this regard, in accordance with identifying an event or set of events (or touchpoints) that contribute to a desired outcome (e.g., a conversion), the attribution model can be used to assign an attribution value or weight to such events. Attribution generally refers to a portion of credit for an event(s) resulting in a particular outcome (e.g., a conversion, such as a purchase or order placed via a website). In embodiments, the particular outcome relates to revenue or conversions. A conversion generally refers to an action taken or completed by an individual or client, such as an action achieving a marketing goal (e.g., user purchases an item for sale, completes and submits a form, etc.). In this way, an attribution model can be a model (e.g., rules, algorithm, etc.) that determines how revenue is assigned to touchpoints or events in an event path (e.g., a path to a conversion or revenue). Marketers may use attribution models to learn what combination of events are most effective at driving a customer or client to convert. The attribution results from the attribution models can be used to determine various information, such as return on investment (ROI) for marketing efforts, optimize marketing spend, and/or the like. As such, a marketer understanding attribution for various events enables the marketer to allocate spending to maximize return on investment.

As described, an attribution model is used to assign credit to various events on an event path, for example, resulting in a conversion. An event path refers to a sequence of events or actions that are performed or engaged with in traversing a path to an outcome (e.g., a positive or successful outcome). An event or touchpoint refers to any event or point along an event path of achieving a conversion or other outcome (e.g., revenue means/goal). Generally, an event may be an interaction or action performed or detected via a computer (computer-based events). Events may be performed by, or engaged in, by a user (e.g., user selection or user viewing). Events may alternatively or additionally be performed via computing activity (e.g., initiated via a marketer), such as communicating an email. Examples of computer-based events include selecting or clicking on a particular product link, navigating to a particular website, a selection of a social network post, a viewing of a social network post or advertisement, performing a search, viewing a paid social post, viewing an email, and the like. As can be appreciated, in some cases, an activity can be a conversion in one model and an event in another. For instance, a free trial might be a touchpoint for a paid subscription, but one may also want to know what marketing activity deserves credit for getting individuals signed up for free trials.

Various attribution models may be used, for example, in the form of heuristics, rules, and/or algorithms. Algorithmic or probabilistic attribution uses automated computation and data-based modeling to determine and assign credit across touchpoints and events preceding the conversion. One example of an algorithmic or probabilistic attribution includes a causal-based attribution model or approach, which is described in more detail herein.

As shown in FIG. 2, attribution manager 202 can include a data set collector 204, an event attributor 206, and an attribution provider 208. The attribution manager 202 can communicate with or access a data store 210. The foregoing components of attribution manager 202 can be implemented, for example, in operating environment 100 of FIG. 1. In particular, those components may be integrated into any suitable combination of user device(s) 102, client device(s) 106, and/or server(s) 108.

Data store 210 can store computer instructions (e.g., software program instructions, routines, or services), data, and/or models (e.g., attribution models) used in embodiments described herein. In some implementations, data store 210 stores information or data received or generated via the various components of attribution manager 202 and provides the various components with access to that information or data, as needed. Although depicted as a single component, data store 210 may be embodied as one or more data stores. Further, the information in data store 210 may be distributed in any suitable manner across one or more data stores for storage (which may be hosted externally).

In embodiments, data stored in data store 210 includes event data, attribution data, and/or the like. Event data generally refers to data associated with an event path, or events associated therewith. As such, event data can include data pertaining to or related to an event path(s) and/or corresponding events. Event data may include interaction data indicating interactions with websites, applications, etc. In this regard, as data is accumulated in relation to client progress through an event path, the data can be stored in data store 210. The events associated with an event path may be stored in association with the event path. Event data may include, for example, a type of an event, a time associated with an event, a client associated with an event, an outcome associated with a set of events (e.g., an outcome of the event path, such as a conversion), and/or the like. Attribution data generally refers to data associated with an attribution(s). Attribution data may be associated with various events, event paths, attribution models, etc.

Determining event attribution, via the attribution manager 202, may be initiated or triggered in any number of ways. As one example, in some embodiments, a user (e.g., marketer) may select to view results or output associated with a set of attribution models or a particular attribution model, such as a causal-based attribution model. By way of example only, a user may select a causal-based attribution model and input a selection to view event contributions associated with such a selected attribution model. For instance, a marketer may wish to identify attribution using a causal-based attribution model. As described above, in some cases, a user may input or select a set of one or more attribution models for which analysis is desired. In other cases, a set of one or more attribution models may be automatically defined (e.g., each attribution model). In other embodiments, event attribution analysis may be automatically triggered or initiated. For instance, upon initiating an application or selecting to view marketing analytics, event attribution analysis may be automatically initiated (e.g. with a default attribution model such as a causal-based attribution model).

The data set collector 204 is generally configured to receive or obtain a data set for use in performing attribution analysis. The data set collector 204 can obtain a data set, which can include various event paths. Each event path may include event data associated with a set of events and an outcome of an event path. Event data may include an indication of an event type and an indication of an event date/time. In this regard, for each event in an event path, an event type and an event date may be obtained. An event type refers to a type of event. Event types may include, but are not limited to, an email, a paid social post, a social impression, a search impression, a search click, etc. An event date may include an indication of a day and/or time corresponding with the event. In some cases, the event date may be an actual date and time. In other cases, the event date may be a relative date (e.g., a number of days prior to a conversion, etc.). An outcome of an event path may indicate whether an event path resulted in a positive outcome or a negative outcome. For example, an outcome may be positive in cases that a conversion is achieved, and an outcome may be negative in cases that a conversion is not identified as being achieved. Although positive and negative event paths are generally described herein in relation to conversion or no conversion, event paths may be related to other positive or negative path outcomes, such as other marketing or revenue aspects associated with a campaign, user engagement with a product, etc.

The data set collector 204 may obtain data sets (e.g., event data) from a data store, such as data store 220. In embodiments, the data store 220 may collect or obtain data from various components, for example, that may monitor for events. For example, a component, such as an event monitor operating on a client device (e.g., client device 106 of FIG. 1) or operating on a remote computing device (e.g., server) that communicates with the client device may monitor for various events and collect data accordingly. By monitoring client interactions (e.g., with web sites, applications, etc.), an event monitor can listen for events, track events, and track paths taken by clients. In accordance with detecting events, an event monitor can record and/or report on such events. As described, such data can be initially collected at remote locations or systems and transmitted to data store 210 for access by data set collector 204.

For example, in some embodiments, event data may be obtained and collected at a client device via one or more sensors, which may be on or associated with one or more client devices and/or other computing devices. As used herein, a sensor may include a function, routine, component, or combination thereof for sensing, detecting, or otherwise obtaining information, such as event data, and may be embodied as hardware, software, or both. In addition or in the alternative to obtaining event data via client devices, such event data may be obtained from, for example, servers, data stores, or other components that collect event data, for example, from client devices. For example, in interacting with a client device, data or usage logs may be captured at various data sources or servers and, thereafter, such event data can be provided to the data store 210 and/or data set collector 204. Event data can be obtained at a remote source periodically or in an ongoing manner (or at any time) and provided to the data store 210 and/or data set collector 204 to facilitate analysis of event attribution.

The particular data set of event data obtained via data set collector 204 can be determined or identified in any number of ways. In some cases, a default set of event data may be obtained. For example, event data associated with event paths initiated or started in the last month may be obtained, or event paths terminated in the last month may be obtained. In other cases, a user (e.g., marketer) may provide an indication of desired event paths to use for the event attribution analysis. For example, a user may select any number of parameters indicating an event path data set to obtain. For instance, a user may select a date range or time parameter (e.g., event data within a defined period of time), a client segment (e.g., client demographic, geography, device type, etc.), or the like. As such, the data set collector 204 may obtain a parameter(s), for example, from a user device operated by a user viewing the attribution analysis data. Any data set parameters may be stored, for instance, at data store 210.

Based on a data set parameter(s), a set of event data can be obtained by the data set collector 204. In embodiments, the data set collector 204 can obtain event data that corresponds with a set of event paths. For example, the data set collector 204 may obtain event type and event date associated with a number of events of as well as an indication of an event outcome (e.g., positive event or negative event). As described, such event data can be accessed via data store 210, which may obtain data from any number of devices, including client devices and/or application servers. For example, a client device used by a client may capture event data in any number of ways, including utilization of sensors that capture information. As another example, a server (e.g., application server) in communication with a client device may gather log or usage data associated with usage of a client device, or portion thereof. Although described as accessing event data from data store 210, event data can alternatively or additionally be obtained from other components, such as, for example, directly from client devices or application servers in communication with client devices, another data store, or the like.

In some cases, the event data may be processed prior to being received at the data store 210. Additionally or alternatively, the data may be processed at the data store 210 or other component, such as data set collector 204 (e.g., to identify outcomes). In this regard, the data store 210 may store raw data and/or processed data. For example, data logs may be mined to identify dates or event types associated with various events. As one example, log data may be analyzed to identify a type of event and an event date associated with an interaction or touchpoint. As another example, log data may be analyzed to identify an outcome associated with an event path. Such data can be stored in the data store (e.g., via an index or lookup system) for subsequent utilization by the data set collector 204.

As can be appreciated, the data set collector 204 can collect event data (e.g., via the data store 220) associated with positive and negative event paths. As described, a positive event path is an event path that results or ends in a positive or desired manner (e.g., successful), and a negative event path is an event path that results or ends in a negative or undesired manner (e.g., unsuccessful).

The event attributor 206 is generally configured to determine attributions for events associated with event paths (e.g., in the obtained data set). In this regard, the event attributor 206 can attribute or designate credit, revenue, and/or cost to an event(s) in an event path leading to an outcome. As such, an attribution, or attribution score, value, or weight, for an event can represent the attribution of the event to the corresponding outcome, such as a conversion. Accordingly, an attribution can be used to quantify the influence an event(s) has on a consumer's decision to make a purchase decision, or other conversion.

As described, attribution identifies and assigns a value to one or more of the events in an event path associated with an outcome. An event or touchpoint generally refers to any event or point along the path flow in association with an outcome, such as achieving a conversion or other revenue means. An event may be, for example, an advertisement displayed on a webpage, a click on an advertisement, a social network post, an email communication, etc. Generally, there are multiple touchpoints or events, such as advertisement presentations and user selections/navigations, occurring before a conversion is actually performed. As such, the event attributor 206 can identify attributions or attribution scores for any number of events to designate an event or set of events as contributing to the conversion.

The event attributor 206 may use any attribution approach to generate and/or assign attributions to events. To this end, any type of attribution approach, or model, can be used to perform or achieve this attribution, that is, attribute revenue or credit to an event(s). Examples of attribution models include single source attribution, fractional attribution, and algorithm or probabilistic attribution. For instance, attribution models may include a last interaction attribution model, a last non-direct click attribution model, a first interaction attribution model, a linear attribution model, a time decay attribution model, a position based attribution model, an algorithmic attribution model, and/or the like.

In accordance with embodiments described herein, the event attributor 206 determines attributions using a causal-based attribution approach. As described, in some embodiments, a causal-based attribution approach, or model, may be selected by a user (e.g., marketer) for use. In this way, a marketer, or representative thereof, can select a causal-based attribution approach from a set of potential attribution approaches based on the marketer's desired preferences for performing attribution analysis.

In analyzing an event path (e.g., a positive event path) using a causal-based attribution approach, an attribution score or value may be determined for each event of the event path. As such, each event path (e.g., resulting in a conversion) can correspond with a set of attribution scores or values for each of the events in the path. By way of example only, assume a causal-based attribution approach is being used to identify attributes for a first positive event path having event 1, event 2, and event 3 and a second positive event path having event 4, event 5, and event 6. In such a case, event attributor 206 can execute the causal-based attribution approach in association with the first positive event path to obtain a first set of attributions that correspond with event 1, event 2, and event 3, respectively. Event attributor 206 can also execute the causal-based attribution approach in association with the second positive event path to obtain a second set of attributions that correspond with event 4, event 5, and event 6, respectively.

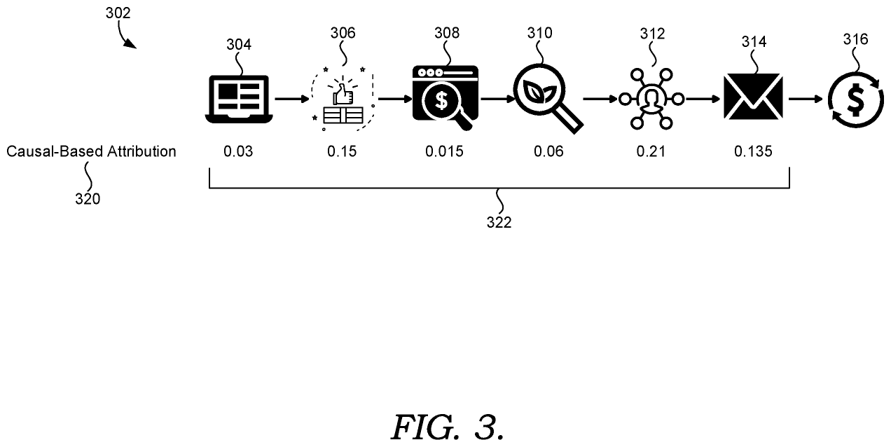

FIG. 3 provides an example with regard to an event path 302. As illustrated, event path 302 includes event 304, event 306, event 308, event 310, event 312, and event 314 that result in an outcome 316 (e.g., conversion). The event attributor 206 can execute a causal-based attribution approach 320. As shown, using the causal-based attribution approach, a set of attributions 322 are generated for each event of the event path 302. For example, for the causal-based attribution approach 320, a 0.03 attribution score is determined for event 304, a 0.15 attribution score is determined for event 306, a 0.015 attribution score is determined for event 308, and so on.

As described, the event attributor 206 can implement a causal-based attribution approach to determine attribution associated with events of an event path(s). The event attributor 206 may include various components. In embodiments, the event attributor 206 includes a conditional intensity model trainer 220, a causal graph generator 222, a direct attribution determiner 224, and an adjusted attribution determiner 226. Such components 220, 222, 224 and 226 can be used to implement a causal-based attribution approach as described herein. Any number of components can be used to implement a causal-based attribution approach, and the components illustrated herein is not intended to be limiting.

The conditional intensity model trainer 220 is generally configured to generate or train a conditional intensity model. A conditional intensity model or function generally refers to a function that uniquely determines the probability structure of a point process. Stated differently, a conditional intensity model refers to a temporal point process describing how the probability that a point of the process occurs at a particular point depends on the prior events in the process. In embodiments, a conditional intensity function defines a Hawkes process. A Hawkes process generally refers to a model for a self-exciting temporal point process, in which the occurrence of an event increases the rate of occurrence of another event for a period of time. In a self-exciting temporal point process, a previous event typically excites, or increases the probability of occurrence, of a subsequent event. In Hawkes process, an event occurrence at a time excites subsequent events and, as such, the intensity function increases. A greater conditional intensity indicates a greater chance of an outcome (e.g., conversion) to occur.

In one implementation, a Hawkes model is defined by the following conditional intensity function used to describe the propensity for a discrete event to occur as a function of time:

λe(t| [symbol] ₜ)=μₑ+Σ_{k∈ε}αₖₑ∫₀^{t}νₖₑ(t−u)dNₖ(u), for e∈ε.

In this model, {Nₑ(t)}_{e∈ε}, where ε={1, . . . , p}, is a vector of point processes (or counting functions). The constant μₑ≥0 denotes a baseline intensity function. The component νₖₑ(x) denotes a non-negative, decreasing function ∫₀^{∞}tνₖₑ(t)dt<∞, for example, νₖₑ(x)=σₖₑe^{-σ}^{ₖₑ}^{x} is the exponential decaying function. In this way, for the event pair ke, σₖₑ denotes a rate of decay, and ∫₀^{t}dNₖ(u)=Nₖ(t)−Nₖ(0) denotes a number of exponentials (or other decay functions) and an extent of effect on the intensity function (e.g., a probability an event occurring over a certain time period is determined by past activities).

In determining conditional intensity for an event, λₑ(t| [symbol] ₜ), at a given time t, μₑ denotes a baseline parameter. A baseline parameter generally indicates an extent of propensity for an event to occur without any stimulus. In this regard, a baseline parameter indicates an effect that is not explainable by other activities. For example, with regard to a search event, some amount of effect can be explained by other events (e.g., search impressions, social impressions, etc.), but other effect is not explained (which is referred to as the baseline parameter).

The parameter αₖₑ≥0 denotes a causal parameter. A causal parameter generally indicates an extent of excitation on an occurrence of another event. In embodiments, a causal parameter reflects Granger causality. Granger causality indicates that past values of an event are used to predict another event. Granger causality is a way to investigate causality between two variables in a time series. If the history of type-k event helps to predict type-e event above and beyond the history of type-e event alone, type-k event is said to Granger-cause type-e event. In embodiments, αₖₑ represents a Granger causality coefficient, wherein αₖₑ>0 indicates there is an excitation effect from event k to event e, and αₖₑ=0 indicates that there is no Granger causality from event k to event e. The coefficients αₖₑ define the causality graph structure, as discussed herein.

In embodiments, the conditional intensity model trainer 220 trains the model to learn model parameters of the conditional intensity function. In some implementations, the baseline parameter and/or the causal parameter are learned. In this regard, the conditional intensity model trainer 220 trains the model to fit the baseline parameter and the causal parameter to result in a function that measures the propensity of an event occurring in a certain time span.

As one example, machine learning is performed to generate or identify baseline and/or causal parameters. In one embodiment, a baseline parameter is learned in association with different types of events, e, and a causal parameter is learned in association with event pairs, which may be denoted as ke. In some cases, maximum likelihood is used to fit the parameters by modeling the times between events. In performing machine learning to train the conditional intensity model, a loss function is used to minimize the loss such that parameters, such as baseline and/or causal parameters, are learned.

To train the conditional intensity model, various event paths can be used to fit data to learn model parameters, such as baseline parameters and/or causal parameters. In embodiments, any number of event paths can be used to train the conditional intensity model. For example, event paths, including positive event paths and negative event paths, can be obtained via data set collector 204, or other component, and used to train the conditional intensity model to learn model parameters.

As described, νₖₑ denotes a rate of decay and may be defined as νₖₑ(x)=σₖₑe^{-σ}^{ₖₑ}^{x}. In this regard, there is an exponential decay for the effect of marketing. As can be appreciated, fitting or learning sigma (e.g., via machine learning) may not be computationally practical. Sigma represents the rate of decay, for example, for a positive effect of advertising on a conversion or one advertisement on another advertisement. As such, in embodiments, sigma can be specified or automatically determined as a hyperparameter such that it is set in advance of learning other parameters. Stated differently, to facilitate learning of baseline parameters and/or causal parameters, the sigma parameters are hyperparameters that are established in advance of training the conditional intensity model. In particular, the machine learning algorithms can include preset hyperparameters, including the sigma parameters for each event type pair. In some embodiments, the decay function may not be an exponential and may have one or more hyperparameters. However, the procedure for predetermining these hyperparameters is general and works for any arbitrary function.

In accordance with embodiments described herein, the conditional intensity model trainer 220, or other component can set a hyperparameter(s) (e.g., sigma) in an efficient and scalable manner prior to performing machine learning to learn model parameters, such as baseline parameters and/or causal parameters. In particular, the sigma hyperparameters can be determined by fitting an exponential distribution to the time differences between two events of paired type (e.g., the conversion and search click) where both events used in each difference are drawn from the same event path. In this way, every event pair can have a unique sigma. More broadly, other types of decay functions can be used in place of an exponential, such as a sum of gaussians or a power law. Parameters for these distributions can be determined in essentially the same way.

By way of example only, assume a conversion and a display event occur at two different times. In such a case, a distribution can be generated in association with the event pair and, thereafter, an exponential fit to the distribution. In embodiments, a regression machine learning approach is used to perform the exponential fit to the distribution. Such sigma hyperparameter determines or specifies the rate of decay function, ν. In this regard, the rate of decay shape depends on the determined sigma hyperparameter. In embodiments, a sigma hyperparameter may be determined for each event pair. Advantageously, determining sigma via a simple exponential fit can be performed very efficiently (e.g., in seconds), which is much more computationally efficient as compared to performing a grid search to identify the sigma hyperparameter. Although an exponential is used as an example for the decay function here, other decay functions may be used instead and may contain one or more parameters to be fit. Identifying or selecting hyperparameters in advance enables a scalable process.

The causal graph generator 222 is generally configured to generate a causal graph. A causal graph, as used herein, generally refers to a probabilistic graphical model used to encode cause and effect relationships between events. In embodiments described herein, a causal graph is generated to indicate Granger causality between events. In this regard, the causal parameters, or coefficients αₖₑ, define the causality graph structure. As such, the causal parameters identified via the conditional intensity model training can be used to generate a causal graph. The causal parameters may be represented in the form of a matrix.

In some case, Lasso regression, or L1 regularization may be applied to a matrix of causal parameters. The L1 regularization technique reduces over-fitting by shrinking coefficients (weights) towards zero. In particular, in some cases, edges between such events may be sparse. For example, in practice, a causal parameter with a zero value may be expected, but in calculation when the loss function is minimized a small value is determined. As such, to learn a zero pattern such that a sparse causal graph is generated, L1 regularization can be applied to the causality coefficient matrix A to learn zero values:

$${min}_{μ , A} \frac{1}{n} {\sum }_{j = 1}^{n} L ( {D}_{j} ; μ , A ) + γ {‖ A ‖}_{1}$$

Where Dⱼ is an event path and ∥A∥₁ is 1-norm of A:

$${‖ A ‖}_{1} = {\sum }_{k , e ∈ ε} \vert {α}_{k e} \vert$$

Generally, a penalty term is used with respect to the absolute value of the causal parameter. Other regularization methods can also be applied, such as elastic net and L₂ regularization.

Causal graphs can be generated in any number of forms. In one embodiment, a causal graph is generated in a graphical form with vertices that indicate various events and edges that indicate direct causal relationships between events. A directed graph is generated to represent the dependence among various types of events. The directed arrows represent Granger causality among different types of events. To generate such a causal graph, the set of causal parameters may be accessed or referenced, for example, via a matrix of causal parameters. In instances in which the causal parameter associated with a pair of events is zero, there is no edge provided to represent any causality between such events. In instances in which the causal parameter associated with a pair of events is greater than zero, an edge is represented between such events.

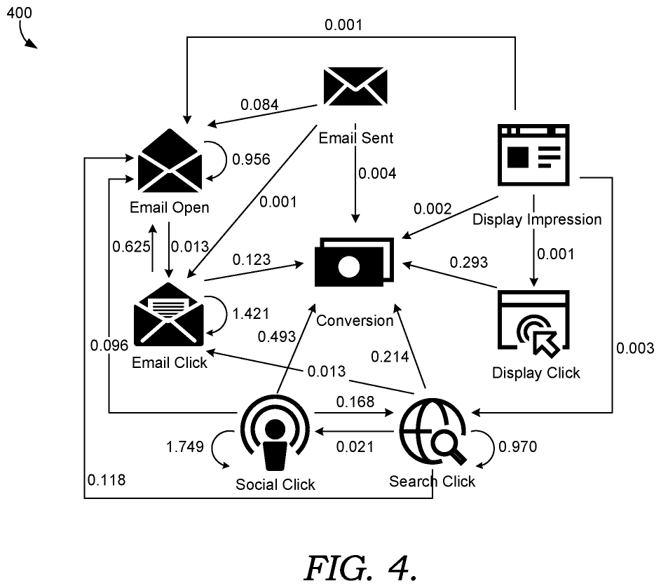

By way of example and with reference to FIG. 4, FIG. 4 illustrates one example of a causal graph 400. In FIG. 4, the direct causal relationships are indicated via directional arrows and the corresponding causal parameters, or Granger causalities, are represented via values adjacent to the directional arrows.

The direct attribution determiner 224 is generally configured to determine direct attribution for events, such as events in an event path ending in a conversion. In this regard, for a sequence of events, or an event path, the direct attribution determiner 224 can determine direct attribution values for one or more of the events. A direct attribution generally refers to an attribution score that results from a direct effect of an event on a conversion. In embodiments, the direct attribution determiner 224 determines attribution values for each event of an event path. In other embodiments, the direct attribution determiner 224 determines attribution events for a portion of events of an event path (e.g., an attribution is determined for each user-initiated event).

An attribution weight may generally be determined by normalizing the conditional intensity function at the point of conversion and assigning attribution weights based on the contribution from each event in the event path. Normalization means that the intensity function equals 1.0 at the point of the conversion, and the contribution from each touchpoint is scaled accordingly. If the baseline, μₑ, is included in the normalization process, then the attribution weights are incremental. As such, the attribution scores represent the incremental increase in the probability of a conversion, considering that the conversion may have been caused by factors beyond the other events in the model. If the baseline is not included in the normalization process, then the scores are fractional. In this regard, the weights represent the relative credit that belongs to each event along the event path or the fraction of credit distributed amongst the configured touchpoints.

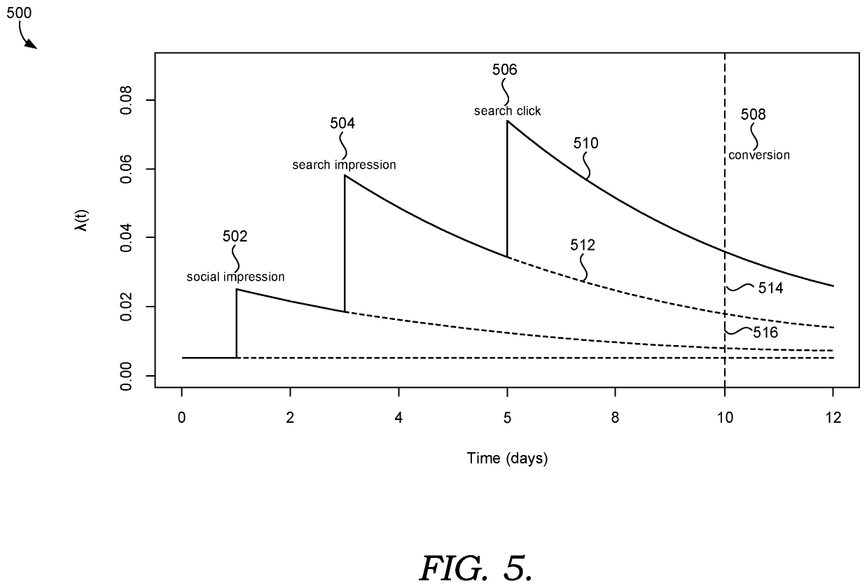

By way of example only, and with reference to FIG. 5, assume a user a is exposed to three events social impression 502, search impression 504, and search click 506, followed by a conversion 508. Line 510 plots the conditional intensity for user a for a conversion. Now assume the event path of user b is without the search click. As such, the event path for user b is social impression 502, search impression 504, followed by conversion 508. Removing search click 506 from this event path results in line 512 plotting the conditional intensity for user b for a conversion. As such, line 510 represents the conditional intensity associated with user a, and line 512 represents the conditional intensity associated with user b. The difference 514 between line 510 and 512 in relation to the conversion results from the search click event 506. In this way, such a difference 514 indicates the marginal lift caused by a search click event 506 in relation to a conversion 508.

As can be appreciated, to calculate conditional intensity for determining a direct attribution for an event, various parameters may be used for the conditional intensity. For example, an appropriate baseline parameter and time decay hyperparameters (e.g. sigma) can be used. In embodiments, to generate a graph, such as the graph 500 illustrated in FIG. 5, the conditional intensity model and appropriate parameters associated with events in an event path can be used to plot such a graph. To this end, upon identifying appropriate parameters (e.g., for conversion), conditional intensities are used to determine attribution weights that are plotted (e.g., as shown in FIG. 5).

Returning to FIG. 2, the adjusted attribution determiner 226 is generally configured to determine adjusted attribution for events, such as events in an event path ending in a conversion. In this regard, for a sequence of events, or an event path, the adjusted attribution determiner 226 can determine adjusted attribution values for one or more of the events. In embodiments, the adjusted attribution determiner 226 determines adjusted attribution values for each event of an event path. In other embodiments, the adjusted attribution determiner 226 determines adjusted attribution events for a portion of events of an event path (e.g., an adjusted attribution is determined for each user-initiated event).

An adjusted attribution generally includes a direct attribution and an indirect attribution. As described, the direct attribution is based on the conditional intensity in relation to a conversion. An indirect attribution generally refers to attribution attained based on excitation or causing of another event in the sequence to result in conversion. In embodiments, an adjusted attribution applies a graphical correction to increase an attribution weight of an earlier event that excited or had a causal relationship to a subsequent event.

By way of example only, assume two different events, or touchpoints, exist on an event path resulting in a conversion. In particular, assume a touchpoint e representing a search event is excited by a prior touchpoint. For example, a user exposed to an email with a keyword of a product may result in the user subsequently initiating a search of the keyword. As such, the touchpoint e representing a search event is excited by the previous email exposure. In determining the marginal impact, or attribution of the prior email event, the email event cause to conversion may also impact the subsequent search event. As such, when the path of user a and user b are compared to identify attribution, in addition to removing all the of the email events, the search events should also be removed as some of the search events are likely caused by the email event.

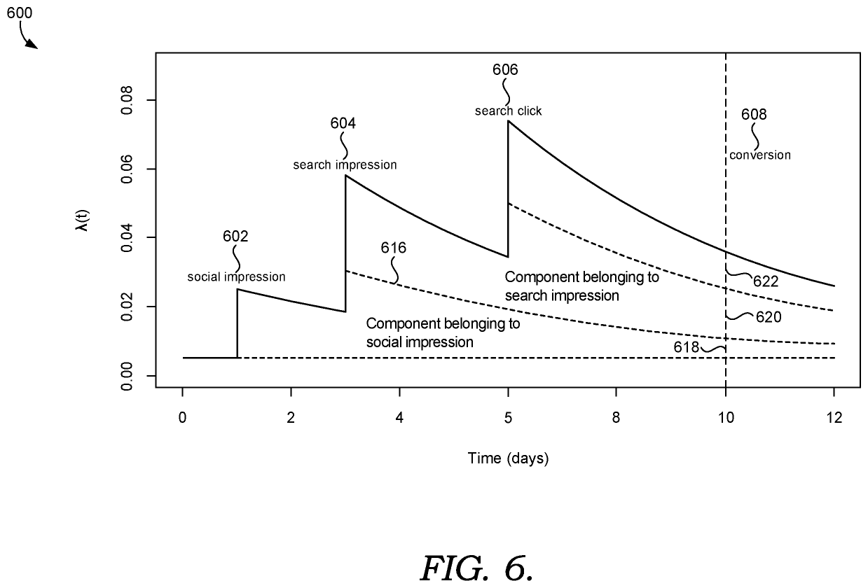

With reference to FIGS. 5 and 6, assume an event path of three events followed by a conversion occurs. With regard to FIG. 5, assume we remove the social impression event 502. In determining the direct attribution, the corresponding marginal lift caused by the search impression is distance 516. However, as shown in FIG. 6, the social impression is illustrated as having a positive impact on the search impression. That is, the search impression is partially caused by the social impression. As such, the social impression obtains some indirect attribution 616 from the search impression. More generally, a parent event, or preceding event, obtains or takes a fraction of a subsequent event attribution (e.g., search impression). In this way, the attribution of the parent or preceding event, in this case social impression, increases its attribution, apart from the direct effect of the event to conversion, as the parent or precedent event facilitates causation of the later or subsequent event.

In embodiments, a causal graph, such as a causal graph generated via causal graph generator 232, and/or alpha matrix can be used to distribute attribution credit back in a way that is related to whether one event causes another event. As such, a causal graph can be used, in addition to a baseline, to redistribute attribution to earlier or preceding events. In some cases, the later event's credit is proportional to its baseline intensity, and earlier events receive remaining credit proportional to their contribution to the intensity. In this regard, an amount of credit originating from a baseline remains with an event (e.g., search click of FIG. 6), and an amount originating from a causal relationship is distributed back as credit to one or more preceding events (e.g., social impression and/or search impression of FIG. 6). Generally, the credit belonging to a current event is distributed between events that cause the current event. Attribution determination can be determined in a sequential manner for each point along the path and assigning credit backwards as the determinations proceed.

As an example, and with reference again to FIG. 6, in determining conditional intensity for search impression 604, a positive alpha is learned from social impression 602 to search impression 604. The marginal lift in the conditional intensity of search impression 604 is then calculated, as described above (which is similar to calculating marginal lift to cause conversion as performed via the direct attribution determiner). Here, the conversion event is replaced with the search impression event. This fraction is how much proportion is owed back to social impression 602. As such, the attribution weight of social impression 602 is the direct attribution of itself to conversion and the indirect attribution resulting from the search impression 604 caused or excited by the social impression. In this way, the adjusted attribution includes the direct attribution weight of the search impression to conversion multiplied by a fraction or proportion caused by social impression (to excite the search impression) that is owed back to the social impression. Line 616 represents the adjusted attribution including both the determined direct and indirect attributions. As such, the adjusted attribution provides an attribution score or weigh with back propagation.

In operation, back propagation can begin at a most recent event to backpropagate credit to previous events and continue to the first event of the event path. For example, with reference to FIG. 6, backpropogation can begin with analysis of the search click 606, then proceed to analysis of the search impression 604. For instance, credit assigned to search click 606 for conversion is now transferred backwards, aside from the baseline which remains with search click 606. Such a process continues until you get to social impression, for which there is no prior event to assign indirect credit.

In this example, as shown, the resulting adjusted attribution 618 for the social impression, the adjusted attribution 620 for the search impression, and the adjusted attribution 622 for the search click are different from the corresponding direct attributions illustrated in FIG. 5. As described, the adjusted attributions capture indirect effects on the conversion based on credit being assigned backwards to events that cause other events having a direct effect on the conversion.

Although FIG. 5 and FIG. 6 visually represent conditional intensity and attribution via graphs, such data can be represented in any manner. For example, such data can be represented and stored as numerical data, such as, for example, an array of numbers. Accordingly, a graphical representation need not be generated, but is provided herein for illustrative purposes.

The attribution provider 208 is generally configured to provide attributions, such as attributions for various events in event paths. In this regard, the attribution provider 208 may provide attributions to a user device, such as a user device operated by a marketer. In some embodiments, attribution values may be associated with the particular attribution models being used to generate the attributions, such as the causal-based attribution model. For example, a listing of each attribution and corresponding events can be provided in association with an indication of the causal-based attribution model to a user device.

In embodiments, attributions may additionally or alternatively be provided for further analysis, such as model analysis. For example, in addition or in the alternative to providing attributions to a user device (e.g., for viewing by a marketer), such attributions may be provided to a data analysis service to identify insights or otherwise analyze data associated with events, for example, leading to conversions. Such insights or analysis may also include suggestions, recommendations, or other data derived and/or related to the attribution model. In some cases, attributions may be used to select or analyze budgets or for budget optimization.

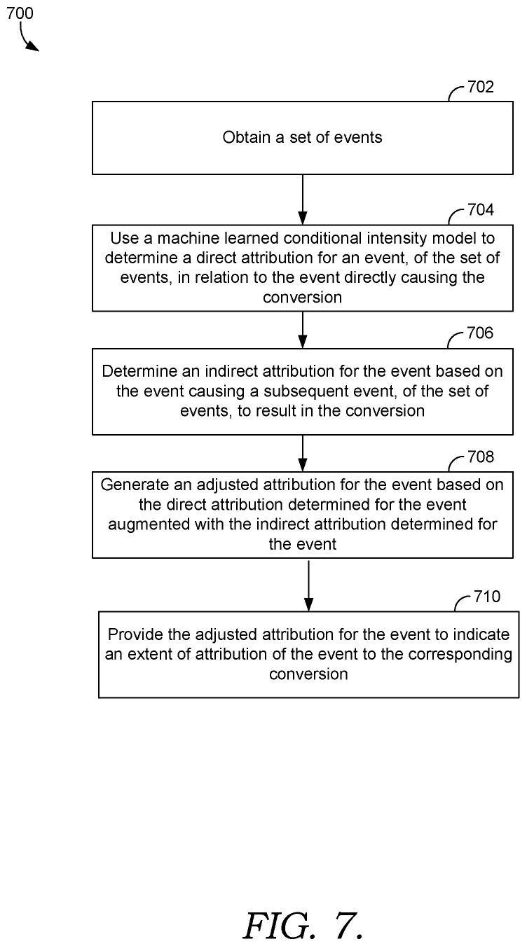

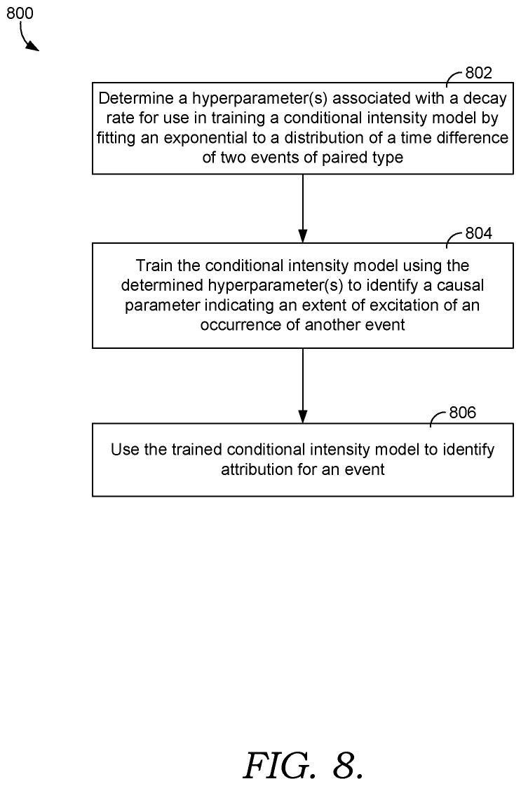

With reference now to FIGS. 7-8, FIGS. 7-8 provide method flows related to facilitating generation and utilization of causal-based models, in accordance with embodiments of the present technology. Each block of method 700 and 800 comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. The method flows of FIGS. 7-8 are exemplary only and not intended to be limiting. As can be appreciated, in some embodiments, method flows 700-800 may be implemented, at least in part, in real time to enable real time data to be provided to a user.

Turning initially to FIG. 7, a flow diagram 700 is provided showing an embodiment of a method 700 for facilitating generating and utilization of causal-based models, in accordance with embodiments described herein. Initially, at block 702, a set of events is obtained. In embodiments, the set of events include various web-based touchpoints resulting in a conversion. At block 704, a machine learned conditional intensity model is used to determine a direct attribution for an event, of the set of events, in relation to the conversion. In embodiments, the machine learned conditional intensity model is trained to fit data associated with event paths to learn model parameters including baseline parameters and causal parameters. In some cases, a direct attribution for the event is determined based on a difference of a first conditional intensity associated with the event and all prior events at conversion time and a second conditional intensity associated with the prior set of events at the conversion time. The first conditional intensity and the second conditional intensity can be determined using the machine learned conditional intensity model.

At block 706, an indirect attribution for the event is determined based on the event causing a subsequent event of the set of events to result in the conversion. An indirect attribution for an event can be determined using a causal graph to backpropagate attribution credit associated with the subsequent event. A causal graph can be generated based on causal parameters learned in association with training the machine learned conditional intensity model. In one embodiment, the indirect attribution for the event is determined based on a causal parameter associated with the event and the subsequent event. Such a causal parameter can include a Granger causality determined by training the machine learned conditional intensity model. At block 708, an adjusted attribution for the event is generated based on the direct attribution determined for the event augmented with the indirect attribution determined for the event. Thereafter, at block 710, the adjusted attribution for the event is provided to indicate an extent of attribution of the event to the corresponding conversion.

Turning to FIG. 8, a process flow is provided showing an embodiment of a method 800 for facilitating analysis of attribution models, in accordance with embodiments described herein. At block 802, a hyperparameter(s) associated with a decay rate for use in training a conditional intensity model is determined by fitting an exponential to a distribution of a time differences of two events of paired type, for example, where both events used in each difference are drawn from the same event path. In embodiments, the hyperparameter is uniquely determined for the two event types of the set of event types. Of note, other functions besides an exponential may be used without impacting the basic procedure. At block 804, the conditional intensity model is trained using the determined hyperparameter(s) to identify a causal parameter indicating an extent of excitation of an occurrence of another event. The conditional intensity model can be trained using a set of positive event paths that result in conversions and a set of negative event paths not resulting in conversions. In some embodiments, the conditional intensity model is further trained to identify a baseline parameter that indicates an extent of propensity for the event to occur without any stimulus. At block 806, the trained conditional intensity model is used to identify attribution for an event. In some cases, the trained conditional intensity model is used to identify direct attribution associated with the event and/or indirection attribution associated with the event.

Having described embodiments of the present invention, FIG. 9 provides an example of a computing device in which embodiments of the present invention may be employed. Computing device 900 includes bus 910 that directly or indirectly couples the following devices: memory 912, one or more processors 914, one or more presentation components 916, input/output (I/O) ports 918, input/output components 920, and illustrative power supply 922. Bus 910 represents what may be one or more busses (such as an address bus, data bus, or combination thereof). Although the various blocks of FIG. 9 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. The inventors recognize that such is the nature of the art and reiterate that the diagram of FIG. 9 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 9 and reference to “computing device.”

Computing device 900 typically includes a variety of computer-readable media. Computer-readable media can be any available media that can be accessed by computing device 900 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 900. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 912 includes computer storage media in the form of volatile and/or nonvolatile memory. As depicted, memory 912 includes instructions 924. Instructions 924, when executed by processor(s) 914 are configured to cause the computing device to perform any of the operations described herein, in reference to the above discussed figures, or to implement any program modules described herein. The memory may be removable, non-removable, or a combination thereof. Exemplary hardware devices include solid-state memory, hard drives, optical-disc drives, etc. Computing device 900 includes one or more processors that read data from various entities such as memory 912 or I/O components 920. Presentation component(s) 916 present data indications to a user or other device. Exemplary presentation components include a display device, speaker, printing component, vibrating component, etc.

I/O ports 918 allow computing device 900 to be logically coupled to other devices including I/O components 920, some of which may be built in. Illustrative components include a microphone, joystick, game pad, satellite dish, scanner, printer, wireless device, etc. I/O components 920 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on computing device 900. Computing device 900 may be equipped with depth cameras, such as stereoscopic camera systems, infrared camera systems, RGB camera systems, and combinations of these, for gesture detection and recognition. Additionally, computing device 900 may be equipped with accelerometers or gyroscopes that enable detection of motion. The output of the accelerometers or gyroscopes may be provided to the display of computing device 900 to render immersive augmented reality or virtual reality.

Embodiments presented herein have been described in relation to particular embodiments which are intended in all respects to be illustrative rather than restrictive. Alternative embodiments will become apparent to those of ordinary skill in the art to which the present disclosure pertains without departing from its scope.

Various aspects of the illustrative embodiments have been described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features have been omitted or simplified in order not to obscure the illustrative embodiments.

Various operations have been described as multiple discrete operations, in turn, in a manner that is most helpful in understanding the illustrative embodiments; however, the order of description should not be construed as to imply that these operations are necessarily order dependent. In particular, these operations need not be performed in the order of presentation. Further, descriptions of operations as separate operations should not be construed as requiring that the operations be necessarily performed independently and/or by separate entities. Descriptions of entities and/or modules as separate modules should likewise not be construed as requiring that the modules be separate and/or perform separate operations. In various embodiments, illustrated and/or described operations, entities, data, and/or modules may be merged, broken into further sub-parts, and/or omitted.

The phrase “in one embodiment” or “in an embodiment” is used repeatedly. The phrase generally does not refer to the same embodiment; however, it may. The terms “comprising,” “having,” and “including” are synonymous, unless the context dictates otherwise. The phrase “A/B” means “A or B.” The phrase “A and/or B” means “(A), (B), or (A and B).” The phrase “at least one of A, B and C” means “(A), (B), (C), (A and B), (A and C), (B and C) or (A, B and C).”

What is claimed is:

1. A method comprising:
obtaining a set of events comprising touchpoints resulting in a conversion;
determining, via a machine learned conditional intensity model, a direct attribution indicating credit for an event, of the set of events, contributing to the conversion;
determining an adjusted attribution for the event based on the direct attribution for the event augmented with an indirect attribution for the event, the indirect attribution identified, via the machine learned conditional intensity model, based on the event causing a subsequent event of the set of events to result in the conversion; and
providing the adjusted attribution for the event to indicate an extent of credit assigned to the event for causing the corresponding conversion.

2. The method of claim 1 further comprising determining a hyperparameter associated with a decay rate for use in training the machine learned conditional intensity model, the hyperparameter being determined by fitting an exponential to a distribution of a time difference of two events of a pair of event types, wherein the two events are from a same event path.

3. The method of claim 1, wherein the machine learned conditional intensity model is trained to fit data associated with event paths to learn model parameters including a baseline parameter and a causal parameter.

4. The method of claim 1, wherein the indirect attribution for the event is determined using a causal graph to backpropagate attribution credit associated with the subsequent events to the event.

5. The method of claim 4, further comprising generating the causal graph, wherein the causal graph is generated based on causal parameters learned in association with training the machine learned conditional intensity model.

6. The method of claim 5, wherein the causal graph is generated in a graphical form with vertices that indicate the set of events and edges that indicate direct causal relationships between various events of the set of events.

7. The method of claim 1, wherein the direct attribution for the event is determined based on a difference of a first conditional intensity of conversion associated with the event and prior events at conversion time and a second conditional intensity of conversion associated with the prior events at the conversion time.

8. The method of claim 1, wherein the extent of credit assigned to the event comprises an incremental value associated with the event with respect to the conversion.

9. One or more computer-readable media having a plurality of executable instructions embodied thereon, which, when executed by one or more processors, cause the one or more processors to perform a method comprising:
obtaining a set of events comprising various touchpoints resulting in a conversion;
using a machine learned conditional intensity model to determine a direct attribution for an event, of the set of events, contributing to the conversion;
determining an indirect attribution for the event based on the event causing a subsequent event of the set of events to result in the conversion;
generating an adjusted attribution for the event based on the direct attribution determined for the event augmented with the indirect attribution determined for the event; and
providing the adjusted attribution for the event to indicate an extent of attribution of the event to the corresponding conversion.

10. The media of claim 9, wherein the machine learned conditional intensity model is trained to fit data associated with event paths to learn model parameters including a baseline parameter and a causal parameter.

11. The media of claim 9, wherein the indirect attribution for the event is determined using a causal graph to backpropagate attribution credit associated with the subsequent event to the event.

12. The media of claim 11, wherein the causal graph is generated based on causal parameters learned in association with training the machine learned conditional intensity model.

13. The media of claim 9, wherein the indirect attribution for the event is determined based on a first causal parameter associated with the event and the subsequent event.

14. The media of claim 13, wherein the extent of attribution of the event comprises an incremental value associated with the event with respect to the corresponding conversion.

15. The media of claim 9, wherein the direct attribution for the event is determined based on a difference of a first conditional intensity of conversion associated with the event and prior events at conversion time and a second conditional intensity of conversion associated with the prior events at the conversion time, wherein the first conditional intensity and the second conditional intensity are determined using the machine learned conditional intensity model.

16. A computing system comprising:
determining a hyperparameter associated with a decay rate for use in training a machine learning conditional intensity model, the hyperparameter being determined by fitting a function to a distribution of a time difference of two events of a pair of event types, wherein the two events are from a same event path; and
training the machine learning conditional intensity model, using the determined hyperparameter, to identify a causal parameter indicating an extent of excitation of an occurrence of another event, wherein the conditional intensity model is used to identify attribution for an event.

17. The system of claim 16, wherein the hyperparameter is uniquely determined for the event types of the pair of event types.

18. The system of claim 16, wherein the trained machine learning conditional intensity model is used to identify direct attribution associated with the event and indirect attribution associated with the event.

19. The system of claim 16, wherein the machine learning conditional intensity model is trained using a set of positive event paths resulting in conversions and a set of negative event paths not resulting in conversions.

20. The system of claim 16, wherein the machine learning conditional intensity model is further trained to identify a baseline parameter that indicates an extent of propensity for the event to occur without any stimulus.
